(19) United States
(12) Patent Application Publication
(10) Pub. No.: US 2026/0201673 A1
(43) Pub. Date: Jul. 16, 2026

(54) WORK MACHINE

(71) Applicant: KOMATSU LTD., Tokyo (JP)

(72) Inventor: Kazumichi OKAJIMA, Tokyo (JP)

(21) Appl. No.: 19/136,414

(22) PCT Filed: Dec. 19, 2023
(86) PCT No.: PCT/JP2023/045488

§ 371 Date: Jun. 6, 2025

(30) Foreign Application Priority Data
Jan. 18, 2023 (JP) 2023-005775

(51) Int. Cl. E02F 9/08; B60K 11/04

(52) U.S. Cl. CPC E02F 9/0866; B60K 11/04

(57) ABSTRACT

A work machine includes a heat exchanger, a first frame, a second frame, and a fan. The first frame is disposed around the heat exchanger. The second frame is detachably fixed to the first frame and is disposed facing the heat exchanger. The fan is fixed to the second frame and is driven by electric power. The second frame is movable upward with respect to the first frame after being unfixed from the first frame.

### CROSS-REFERENCE TO RELATED APPLICATIONS

This application is a U.S. National stage application of International Application No. PCT/JP2023/045488, filed on Dec. 19, 2023. This U.S. National stage application claims priority under 35 U.S.C. § 119(a) to Japanese Patent Application No. 2023-005775, filed in Japan on Jan. 18, 2023, the entire contents of which are hereby incorporated herein by reference.

### BACKGROUND

### Technical Field

The present invention relates to a work machine.

### Background Information

A work machine such as a hydraulic excavator is provided with a heat exchanger for cooling various fluids (e.g., refrigerant) and a plurality of fans for supplying cooling wind to the heat exchanger. As the heat exchanger, for example, a radiator through which cooling water for an engine passes, an oil cooler through which hydraulic oil for operating a hydraulic actuator passes, and an aftercooler through which compressed air passes are disposed (see, for example, JP 2020-84520 A).

The fans disclosed in JP 2020-84520 A are attached to a shroud, and the shroud is formed up to the heat exchanger and guides the cooling wind from the fans to the heat exchanger.

### SUMMARY

In replacing the fans for maintenance or the like, it is necessary to detach bolts or the like fixing the fans to the shroud and detach the fans individually from the shroud. Unfortunately, the bolts are disposed in a place where other components and the like are located together, making it difficult to replace the fans due to poor detachability.

It is an object of the present disclosure to provide a work machine allowing a fan to be easily replaced.

A work machine according to a first aspect of the present disclosure includes a heat exchanger, a first frame, a second frame, and a fan. The first frame is disposed around the heat exchanger and includes an opening facing the heat exchanger. The second frame is detachably fixed to the first frame and is thus disposed facing the heat exchanger. The fan is fixed to the second frame and is driven by electric power. The second frame is movable upward with respect to the first frame after being unfixed from the first frame.

An aspect of the present disclosure can provide a work machine allowing a fan to be easily replaced.

### BRIEF DESCRIPTION OF DRAWINGS

FIG. 1 is a perspective view illustrating a hydraulic excavator according to an embodiment of the present disclosure.

FIG. 2 is a perspective view of the hydraulic excavator as viewed from the rear.

FIG. 3 is a view when a left surface side is viewed from the inside of an engine room.

FIG. 4 is a perspective view of a cooling unit.

FIG. 5 is a perspective view illustrating a state in which a fan unit is detached from the cooling unit.

FIG. 6 is a view illustrating a state in which a cover frame is detached from the cooling unit.

FIG. 7 is an exploded perspective view of the cooling unit.

FIG. 8A is a perspective view illustrating the fan unit.

FIG. 8B is a front view of the fan unit as viewed from the right.

FIG. 8C is a side view of the fan unit as viewed from the front.

FIG. 8D is a plan view of the fan unit as viewed from above.

FIG. 9 is a top view of FIG. 6.

FIG. 10 is a front view of the cooling unit illustrated in FIG. 3.

FIG. 11A is a perspective view illustrating a revolving body of the hydraulic excavator.

FIG. 11B is an enlarged view of a state in which a top cover of the engine room is opened.

FIG. 12A is a view illustrating a bottom surface of the revolving body of the hydraulic excavator.

FIG. 12B is an enlarged view of FIG. 12A.

FIG. 13A, FIGS. 13B and 13C are schematic side views for describing operation of detaching the fan unit from a heat exchanger unit.

FIG. 14 is a view illustrating a state in which a hose is detached from an inflow port of an aftercooler in FIG. 11B.

FIG. 15 is a view illustrating a state in which the fan unit is moved upward with respect to the heat exchanger unit.

### DETAILED DESCRIPTION OF EMBODIMENT(S)

A hydraulic excavator as an example of a work machine according to the present disclosure will be described below with reference to the drawings.

### Configuration

### Outline of Hydraulic Excavator 1

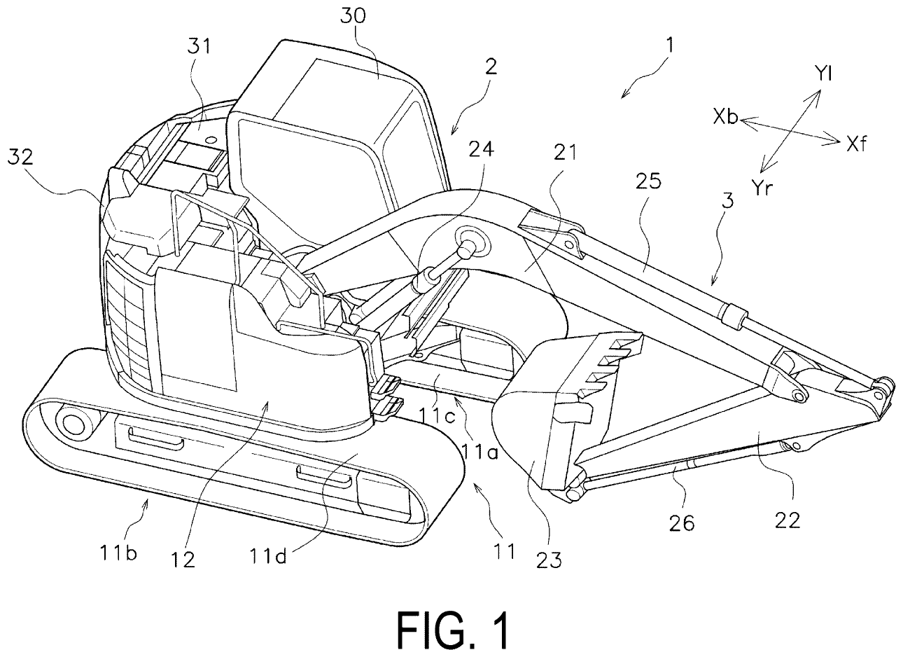

FIG. 1 is a schematic view illustrating a configuration of a hydraulic excavator 1 according to the present embodiment.

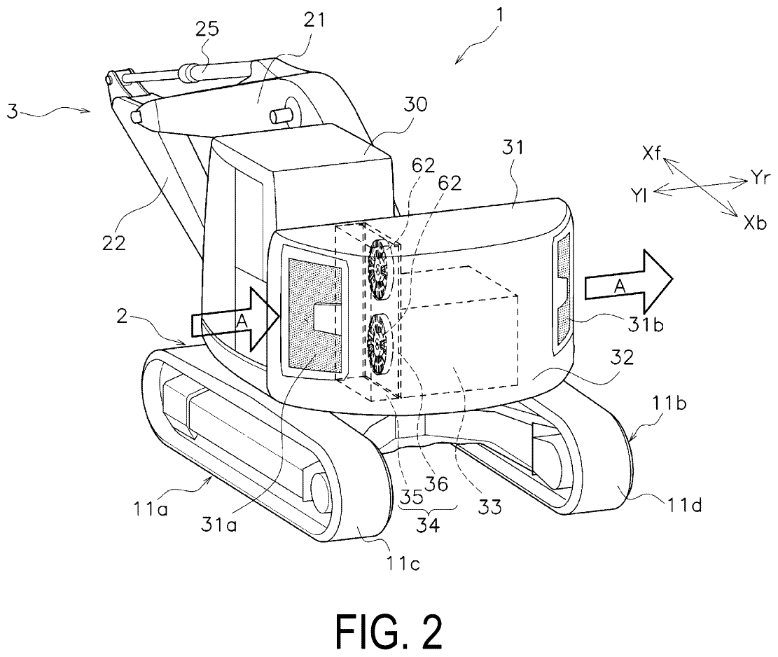

The hydraulic excavator 1 (an example of the work machine) includes a vehicle body 2 and a work implement 3. As illustrated in FIG. 1, the vehicle body 2 includes a traveling body 11 and a revolving body 12. The traveling body 11 includes a pair of traveling devices 11a and 11b. The traveling devices 11a and 11b include crawler tracks 11c and 11d, respectively. A traveling motor is rotated by a driving force from an engine 33 (see FIG. 2 described below) to drive the crawler tracks 11c and 11d, whereby the hydraulic excavator 1 travels.

The revolving body 12 is mounted on the traveling body 11. The revolving body 12 is configured to be rotatable with respect to the traveling body 11 about an axis along the up-down direction by a revolving device (not illustrated). A cab 30 as an operator seat on which an operator sits during operation is provided at a front left position of the revolving body 12. Inside the cab 30, an operator seat, a lever for operating the work implement 3, various display devices, and the like are disposed.

Unless otherwise specified in the present embodiment, the front, rear, left, and right will be described based on the operator seat in the cab 30. A direction in which the operator seat faces the front is referred to as a front direction (see an arrow Xf), and a direction opposite to the front direction is referred to as a rear direction (see an arrow Xb). A right side and a left side of side directions when the operator seat faces the front are referred to as a right direction (see an arrow Yr) and a left direction (see an arrow Yl), respectively. In the present description, unless otherwise specified, a “height direction”, a “vertical direction”, and a “horizontal direction” indicate directions in a state where the vehicle body 2 is not inclined but is horizontal. In the present description, the term “horizontal” does not need to be “horizontal” in a strict sense, may include an error, and is only required to be regarded as being “horizontal” in terms of common sense. In the present description, the term “vertical” does not need to be “vertical” in a strict sense, may include an error, and is only required to be regarded as being “vertical” in terms of conventional sense. In the specification, the term “perpendicular” does not need to be “perpendicular” in a strict sense, may include an error, and is only required to be regarded as being “perpendicular” in terms of common sense.

The work implement 3 is attached at a front center position of the revolving body 12. As illustrated in FIG. 1, the work implement 3 includes a boom 21, an arm 22, and an excavation bucket 23. A base end portion of the boom 21 is rotatably coupled to the revolving body 12. A distal end portion of the boom 21 is rotatably coupled to a base end portion of the arm 22. A distal end portion of the arm 22 is rotatably coupled to the excavation bucket 23. The excavation bucket 23 is attached to the arm 22 such that an opening thereof can face in a direction of the revolving body 12 (rearward). The hydraulic excavator 1 to which the excavation bucket 23 is attached in such a direction is called a backhoe.

Hydraulic cylinders 24 to 26 (boom cylinder 24, arm cylinder 25, and bucket cylinder 26) are disposed so as to correspond to the boom 21, the arm 22, and the excavation bucket 23, respectively. The work implement 3 is driven by driving the hydraulic cylinders 24 to 26. This allows work such as excavation to be performed.

An engine room 31 is disposed behind the cab 30 of the revolving body 12. A counterweight 32 is disposed behind the engine room 31 of the revolving body 12. FIG. 2 is a perspective view schematically illustrating an internal configuration of the engine room 31. FIG. 2 schematically describes the outer shape of the engine room 31 in comparison with FIG. 1 in order to illustrate the internal configuration. The revolving body 12 further includes the engine 33 and a cooling unit 34. The cooling unit 34 and the engine 33 are arranged side by side in order from the left to the right. The engine 33 generates a driving force. The engine 33 is an internal combustion engine such as a diesel engine.

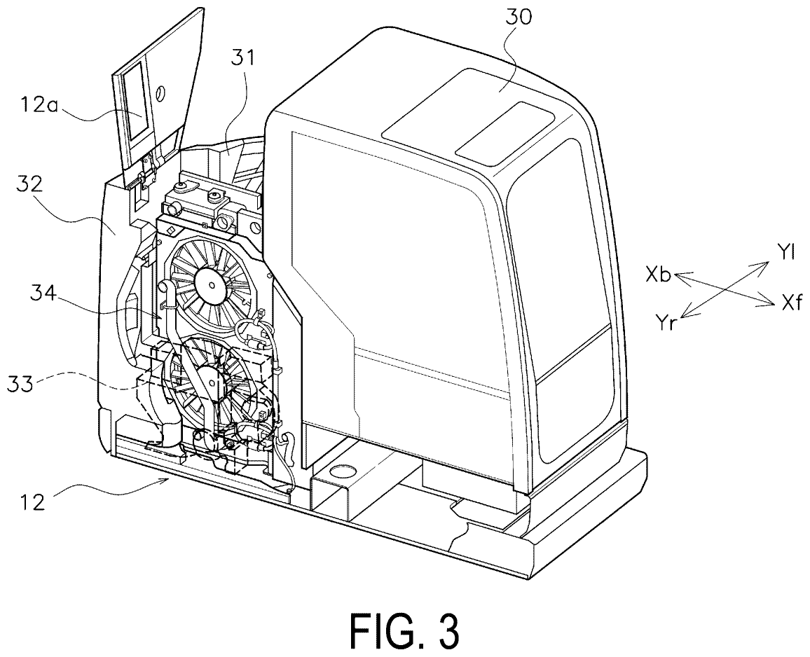

FIG. 3 is a view when a left surface side is viewed from the inside of the engine room 31. FIG. 3 illustrates the engine 33 in a dotted line to indicate the position of the engine 33. The cooling unit 34 cools various cooling target fluids such as a refrigerant and compressed air. As illustrated in FIG. 2, an air port 31a is disposed in a sidewall of the engine room 31 to the left of the cooling unit 34. A net is disposed at the air port 31a. An air port 31b is disposed in a sidewall of the engine room 31 to the right of the engine 33. A net is disposed at the air port 31b. The cooling unit 34 includes a plurality of fans 62. When the fans 62 rotate, external air is taken into the engine room 31 from the air port 31a, as indicated by an arrow A in FIG. 2. The air taken into the engine room 31 passes through the engine 33 and is discharged to the outside from the air port 31b.

### Cooling Unit 34

As illustrated in FIG. 2, the cooling unit 34 includes a heat exchanger unit 35 and a fan unit 36. The heat exchanger unit 35 includes a plurality of heat exchangers (described below) for cooling various cooling target fluids. The fan unit 36 supplies cooling wind to the heat exchanger unit 35.

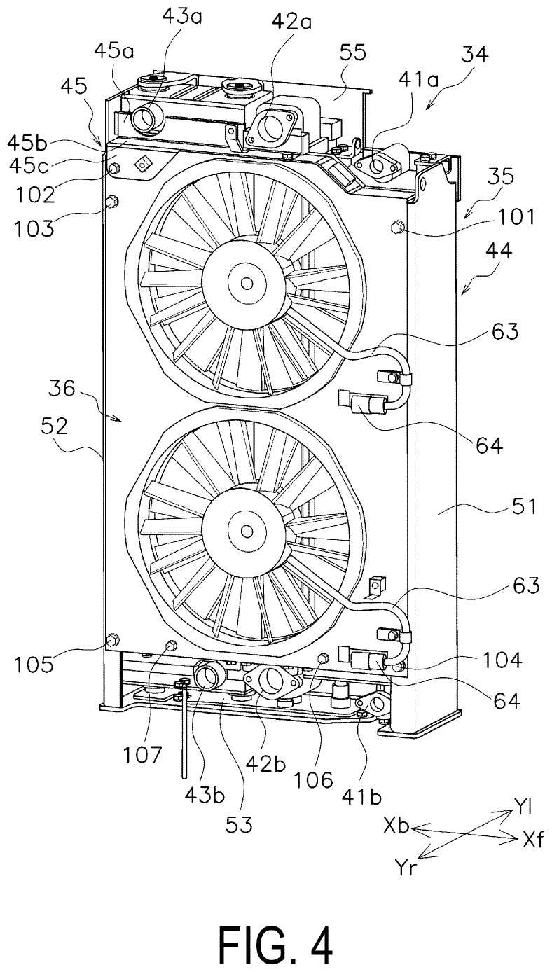

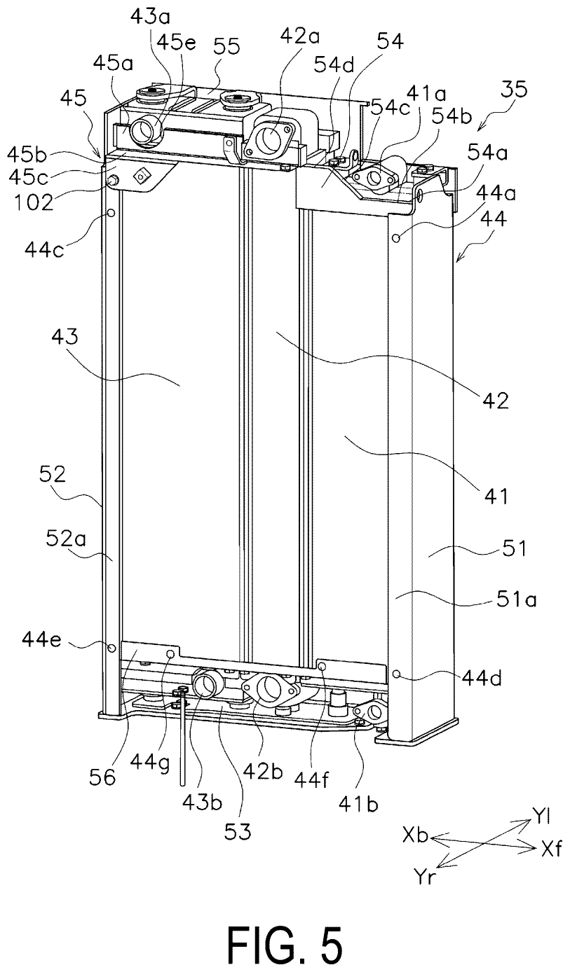

FIG. 4 is a perspective view of the cooling unit 34. FIG. 5 is a perspective view illustrating the heat exchanger unit 35. The heat exchanger unit 35 is disposed to the left of the fan unit 36. The heat exchanger unit 35 is disposed at a side of the fan unit 36 facing the air port 31a. The heat exchanger unit 35, the fan unit 36, and the engine 33 are arranged in order from the air port 31a toward the air port 31b.

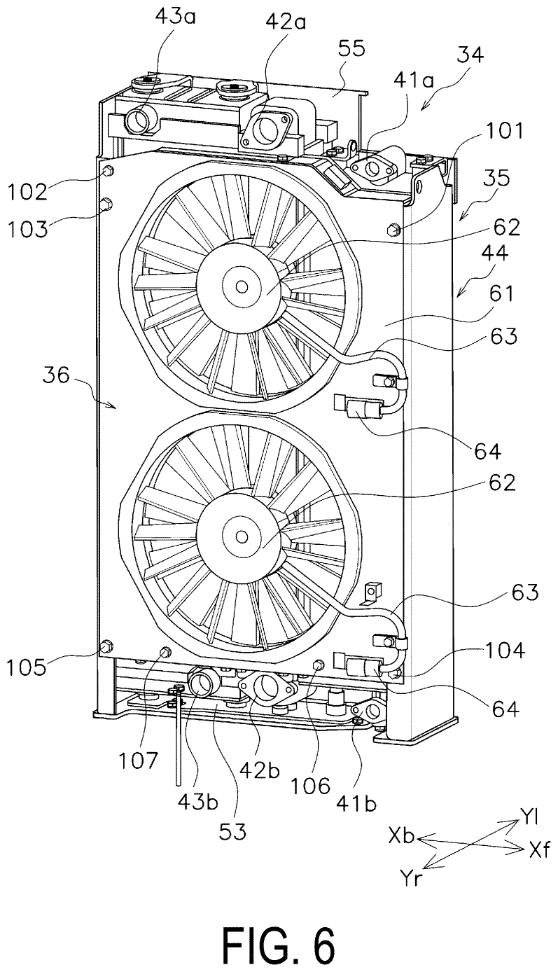

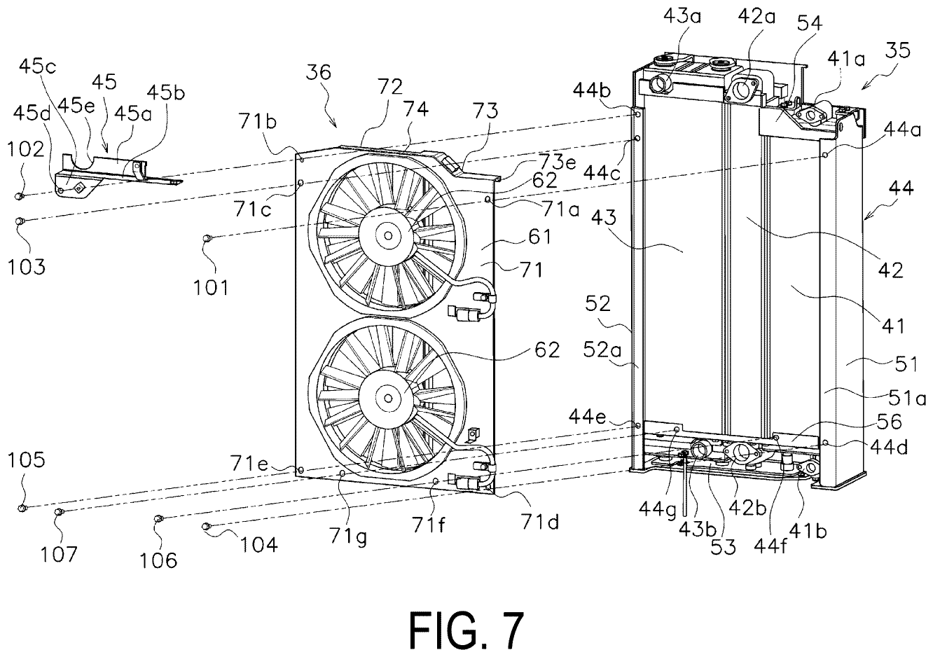

Heat Exchanger Unit 35 As illustrated in FIG. 5, the heat exchanger unit 35 includes an oil cooler 41, an aftercooler 42, a radiator 43, a first frame 44, and an upper cover frame 45. FIG. 6 is a view illustrating a state in which the upper cover frame 45 is detached from the cooling unit 34. FIG. 7 is an exploded perspective view of the cooling unit 34. Each of the oil cooler 41, the aftercooler 42, and the radiator 43 is an example of a heat exchanger.

The oil cooler 41 is supplied with hydraulic oil for operating hydraulic actuators such as the hydraulic cylinders 24 to 26. The hydraulic oil is cooled while passing through the oil cooler 41. The oil cooler 41 is disposed at a front portion of the heat exchanger unit 35. Viewed along the left-right direction of the hydraulic excavator 1, the oil cooler 41 has a substantially rectangular shape long in the up-down direction. The oil cooler 41 includes, at an upper portion thereof, an inflow port 41a into which the hydraulic oil flows. A hose for supplying the hydraulic oil is attached to the inflow port 41a. The oil cooler 41 includes, at a lower portion thereof, an outflow port 41b through which the cooled hydraulic oil flows out. A hose for discharging the hydraulic oil is attached to the outflow port 41b.

External air is taken in and compressed by a supercharger (not illustrated), and the compressed air is supplied to the aftercooler 42. The aftercooler 42 is connected to the engine 33. The compressed air is cooled while passing through the aftercooler 42 and is sent to the engine 33. The aftercooler 42 is disposed behind the oil cooler 41. Viewed along the left-right direction of the hydraulic excavator 1, the aftercooler 42 has a substantially rectangular shape long in the up-down direction. The aftercooler 42 includes, at an upper portion thereof, an inflow port 42a through which the compressed air flows. A hose for supplying the compressed air is attached to the inflow port 42a. The aftercooler 42 includes, at a lower portion thereof, an outflow port 42b through which the cooled compressed air flows out. A hose for discharging the compressed air is attached to the outflow port 42b.

Cooling water of the engine 33 is supplied to the radiator 43. The supplied cooling water is cooled while passing through the radiator 43 and is discharged toward the engine 33. The radiator 43 is disposed behind the aftercooler 42. When viewed along the left-right direction of the hydraulic excavator 1, the radiator 43 has a substantially rectangular shape long in the up-down direction. The radiator 43 includes, at an upper portion thereof, an inflow port 43a through which the cooling water flows. A hose for supplying the cooling water is attached to the inflow port 43a. The radiator 43 includes, at a lower portion thereof, an outflow port 43b through which the cooled cooling water flows out. A hose for discharging the cooling water is attached to the outflow port 43b.

The oil cooler 41, the aftercooler 42, and the radiator 43 are arranged side by side in order from the front toward the rear of the hydraulic excavator 1.

The first frame 44 supports the oil cooler 41, the aftercooler 42, and the radiator 43. The first frame 44 is disposed so as to surround peripheral portions of the oil cooler 41, the aftercooler 42, and the radiator 43 arranged side by side. The first frame 44 includes a front frame portion 51, a rear frame portion 52, a bottom frame portion 53, an upper right frame portion 54, an upper left frame portion 55, and a lower cover frame portion 56.

The front frame portion 51 is disposed in front of the oil cooler 41. The front frame portion 51 is a plate-like member. The front frame portion 51 is disposed along the up-down direction. The front frame portion 51 includes, at a right end thereof, an end portion 51a bent rearward. The end portion 51a is disposed perpendicular to the left-right direction.

The rear frame portion 52 is disposed behind the radiator 43. The rear frame portion 52 is a plate-like member. The rear frame portion 52 is disposed along the up-down direction. The rear frame portion 52 includes, at a right end thereof, an end portion 52a bent forward. The end portion 52a is disposed perpendicular to the left-right direction.

The bottom frame portion 53 is disposed below the oil cooler 41, the aftercooler 42, and the radiator 43. The bottom frame portion 53 has a plate shape. The bottom frame portion 53 is disposed to extend forward from the rear frame portion 52.

The upper right frame portion 54 is disposed to the right of the upper portion of the oil cooler 41. The upper right frame portion 54 is disposed in front of the aftercooler 42 in the front-rear direction. The upper right frame portion 54 is a plate-like member. The upper right frame portion 54 is disposed such that a main surface thereof is perpendicular to the left-right direction. The upper right frame portion 54 is disposed to extend rearward from the front frame portion 51. An upper end 54a of the upper right frame portion 54 is formed such that a rear portion thereof is located above a front portion thereof. The upper end 54a includes a front portion 54b, an inclined portion 54c and a rear portion 54d. The front portion 54b is a front portion of the upper end 54a. The front portion 54b is disposed horizontally. The front portion 54b is located below the inflow port 41a of the oil cooler 41. The rear portion 54d is a rear portion of the upper end 54a. The rear portion 54d is disposed horizontally. The rear portion 54d is disposed below the inflow port 42a of the aftercooler 42 and the inflow port 43a of the radiator 43 in the up-down direction. The inclined portion 54c connects a rear end of the front portion 54b and a front end of the rear portion 54d. The inclined portion 54c is inclined upward toward the rear. It can also be said that a cutout is formed at a portion of the upper right frame portion 54 facing the inflow port 41a of the oil cooler 41. The upper right frame portion 54 is formed so as not to face the inflow port 41a.

The upper left frame portion 55 is disposed to the left of the upper portion of the aftercooler 42 and the upper portion of the radiator 43. The upper left frame portion 55 has a plate shape. The upper left frame portion 55 is disposed perpendicular to the left-right direction. The upper left frame portion 55 is disposed to extend forward from a left end of the rear frame portion 52.

The lower cover frame portion 56 covers a gap between the oil cooler 41, the aftercooler 42, and the radiator 43, and the fan unit 36 from below. The lower cover frame portion 56 is disposed above the bottom frame portion 53. The lower cover frame portion 56 is disposed above the outflow ports 41b, 42b, and 43b. As illustrated in FIG. 5, the lower cover frame portion 56 is disposed between the front frame portion 51 and the rear frame portion 52. The lower cover frame portion 56 is formed to be elongated in the front-rear direction. The lower cover frame portion 56 is fixed to the front frame portion 51 and the rear frame portion 52.

Bolt holes 44a to 44g are formed in the first frame 44. The bolt holes 44a to 44g extend through the first frame 44 along the left-right direction. As illustrated in FIG. 5, the bolt hole 44a is formed in the vicinity of an upper end of the end portion 51a of the front frame portion 51. As illustrated in FIG. 7 described below, the bolt hole 44b is formed in the vicinity of an upper end of the end portion 52a of the rear frame portion 52. As illustrated in FIG. 7, the bolt hole 44c is formed in the vicinity of the upper end of the end portion 52a of the rear frame portion 52 and below the bolt hole 44b. As illustrated in FIG. 5, the bolt hole 44d is formed in the vicinity of a lower end of the end portion 51a of the front frame portion 51. The bolt hole 44e is formed in the vicinity of a lower end of the end portion 52a of the rear frame portion 52. The bolt holes 44f and 44g are formed side by side in the front-rear direction in the lower cover frame portion 56. The bolt hole 44f is disposed in the forward direction of the bolt hole 44g.

As illustrated in FIG. 5, the upper cover frame 45 is disposed to the right of the radiator 43. As illustrated in FIGS. 5 and 7, the upper cover frame 45 covers a gap between the fan unit 36 and the radiator 43 from above. The upper cover frame 45 is formed by bending a plate-like member. As illustrated in FIGS. 5 and 7, the upper cover frame 45 includes an upper portion 45a, a horizontal portion 45b, and a lower portion 45c. The upper portion 45a is disposed in parallel to the upper portion of the radiator 43. The upper portion 45a is disposed perpendicular to the left-right direction. A cutout 45e in which the inflow port 43a is disposed is formed in the upper portion 45a. The horizontal portion 45b protrudes rightward from a lower end of the upper portion 45a. The horizontal portion 45b is disposed horizontally. The lower portion 45c is disposed to extend downward from a right end of the horizontal portion 45b. The lower portion 45c is disposed perpendicular to the left-right direction. A through hole 45d along the left-right direction is formed at a rear portion of the lower portion 45c. As illustrated in FIG. 7, a bolt 102 is inserted through the through hole 45d into the bolt hole 44b formed at an upper portion of the end portion 52a of the rear frame portion 52. Thus, the upper cover frame 45 is fixed to the first frame 44.

### Fan Unit 36

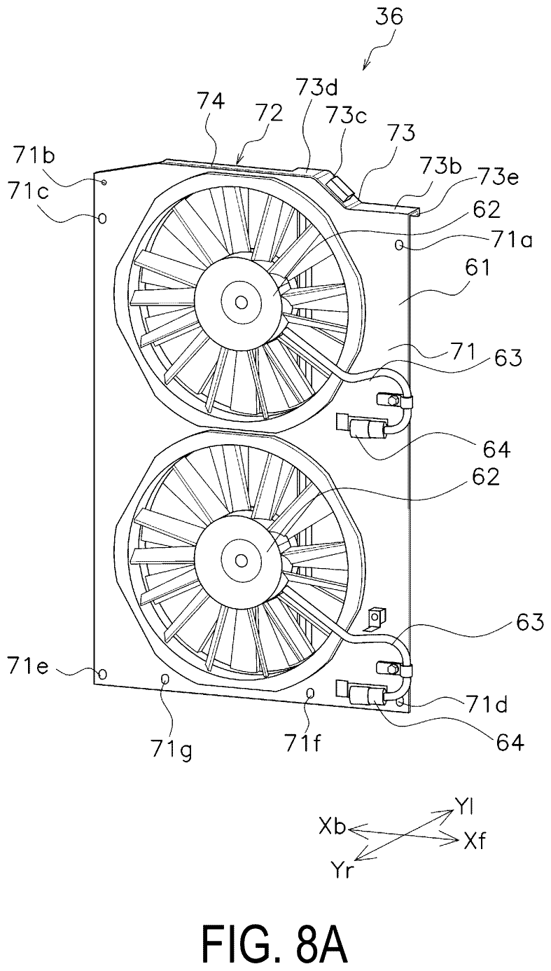

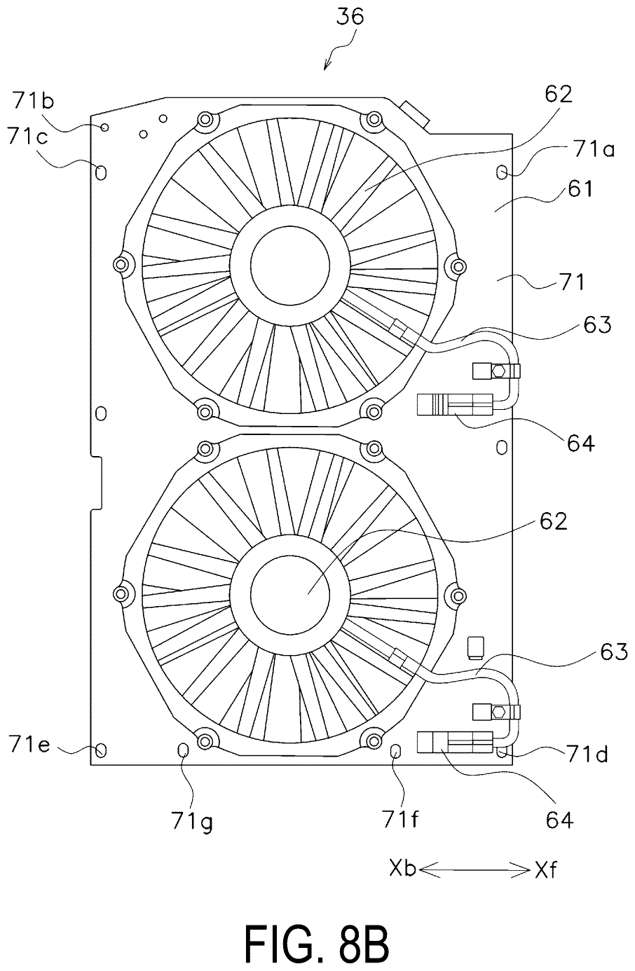

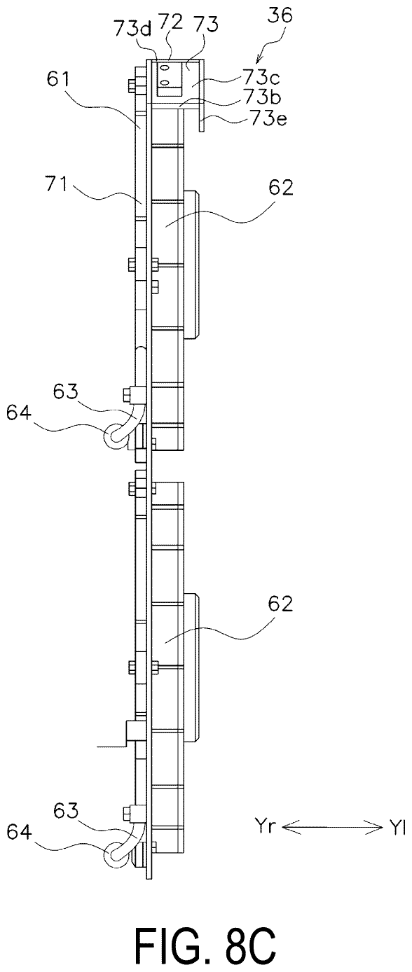

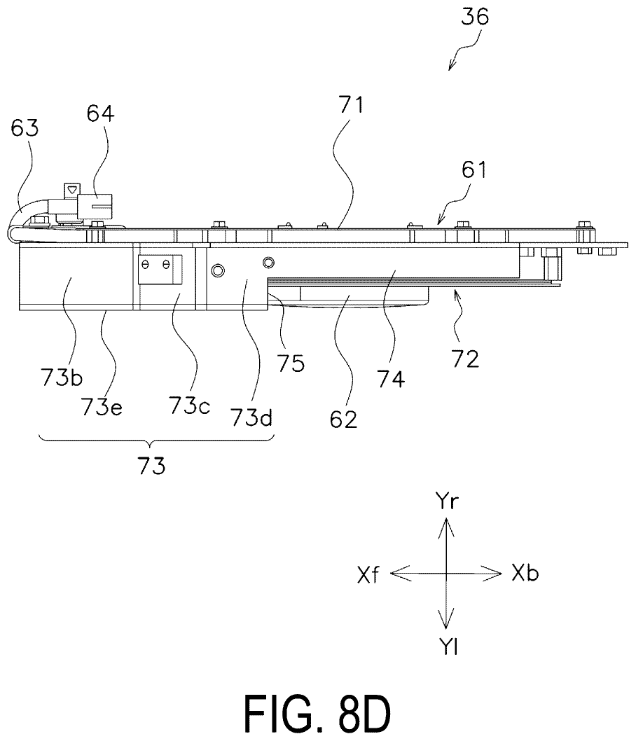

FIG. 8A is a perspective view illustrating the fan unit 36. FIG. 8B is a front view of the fan unit 36 as viewed from the right. FIG. 8C is a side view of the fan unit 36 as viewed from the front. FIG. 8D is a plan view of the fan unit 36 as viewed from above.

The fan unit 36 is disposed so as to face the oil cooler 41, the aftercooler 42, and the radiator 43 serving as heat exchangers.

As illustrated in FIG. 8A, the fan unit 36 includes a second frame 61, a plurality of fans 62, a plurality of first cables 63, and a plurality of connector portions 64. The plurality of fans 62 are rotatably supported by the second frame 61. In the fan unit 36, two fans 62 are arranged side by side in the up-down direction. Each of the fans 62 is disposed such that a rotation axis thereof extends along the left-right direction.

The second frame 61 is detachably attached to the first frame 44 with bolts 101 to 105 described below. The second frame 61 rotatably supports the plurality of fans 62. The second frame 61 is formed by bending, for example, a plate-like member. The second frame 61 includes a fan fixing portion 71 and a protruding portion 72.

The fan fixing portion 71 has a plate shape. The plurality of fans 62 are fixed to the fan fixing portion 71. The fan fixing portion 71 is disposed perpendicular to the left-right direction. Two through holes arranged side by side in the up-down direction are formed in the fan fixing portion 71. The fans 62 are fixed to the respective through holes. As illustrated in FIGS. 8A and 8B, through holes 71a to 71g are formed in the fan fixing portion 71. The through holes 71a to 71g extend through the fan fixing portion 71 in the left-right direction. Bolts are inserted into the through holes 71a to 71g when the second frame 61 is fixed to the first frame 44. The through hole 71a is formed in the vicinity of an upper end of a front end portion of the fan fixing portion 71. The through hole 71b is formed in the vicinity of an upper end of a rear end portion of the fan fixing portion 71. The through hole 71c is formed in the vicinity of the upper end of the rear end portion of the fan fixing portion 71 and below the through hole 71b. The through hole 71d is formed in the vicinity of a lower end of the front end portion of the fan fixing portion 71. The through hole 71e is formed in the vicinity of a lower end of the rear end portion of the fan fixing portion 71. The through hole 71f is disposed in the vicinity of a lower end of the fan fixing portion 71 and more forward than the center in the front-rear direction. The through hole 71f is disposed behind the through hole 71d. The through hole 71g is disposed in the vicinity of the lower end of the fan fixing portion 71 and more rearward than the center in the front-rear direction. The through hole 71g is disposed in front of the through hole 71e. The through hole 71g is disposed behind the through hole 71f.

As illustrated in FIG. 8D, the protruding portion 72 is disposed so as to protrude from an upper end of the fan fixing portion 71 toward the first frame 44. The protruding portion 72 is formed to extend leftward from the upper end of the fan fixing portion 71. The protruding portion 72 includes a first protruding portion 73 (an example of a locked portion), a second protruding portion 74, and a cutout portion 75. The first protruding portion 73 is a front portion of the protruding portion 72. The second protruding portion 74 is a rear portion of the protruding portion 72. The first protruding portion 73 extends more leftward than the second protruding portion 74. A rear end of the first protruding portion 73 and a left end of the second protruding portion 74 form the cutout portion 75.

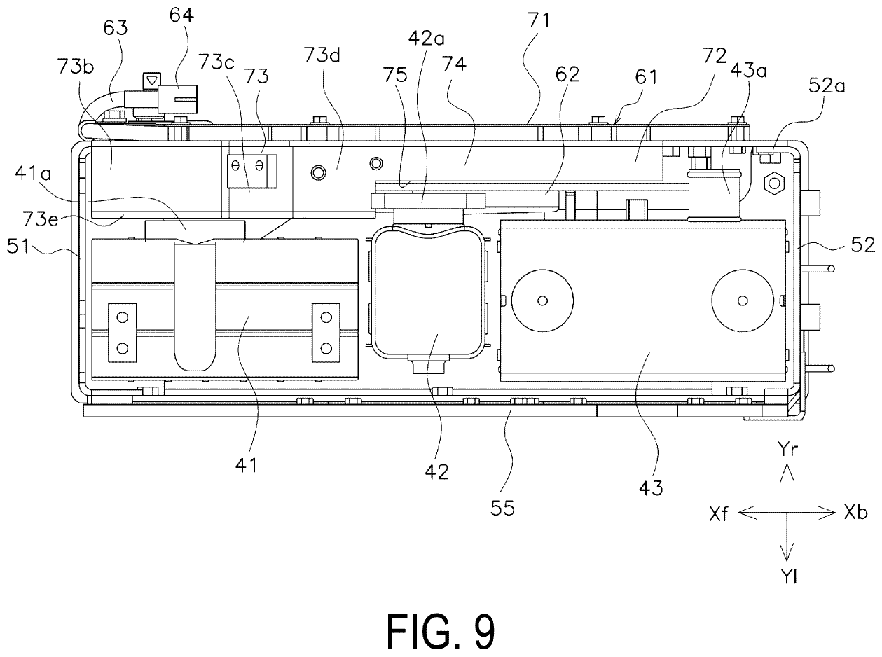

The second protruding portion 74 is disposed horizontally. FIG. 9 is a top view of FIG. 6. The second protruding portion 74 is disposed in the forward direction of the inflow port 43a of the radiator 43. As illustrated in FIG. 9, the protruding portion 72 is not formed below the inflow port 43a of the radiator 43. The cutout portion 75 is disposed substantially below the inflow port 42a of the aftercooler 42.

As illustrated in FIG. 9, the first protruding portion 73 is disposed to the right of the inflow port 41a of the oil cooler 41. The first protruding portion 73 is locked to the upper right frame portion 54 of the first frame 44.

As illustrated in FIGS. 8A, 8C, and 8D, the first protruding portion 73 includes a front portion 73b, an inclined portion 73c, a rear portion 73d, and an end portion 73e. The front portion 73b is a front portion of the first protruding portion 73. The front portion 73b is disposed horizontally. The rear portion 73d is a rear portion of the first protruding portion 73. The rear portion 73d is disposed horizontally. A rear end of the rear portion 73d is connected to the second protruding portion 74. The inclined portion 73c connects a rear end of the front portion 73b and a front end of the rear portion 73d. The inclined portion 73c is inclined upward toward the rear. As illustrated in FIGS. 8A and 8C, the end portion 73e is disposed to extend downward from a left end of the first protruding portion 73. The end portion 73e is formed over an entire left end of the front portion 73b, an entire left end of the inclined portion 73c, and an entire left end of the rear portion 73d.

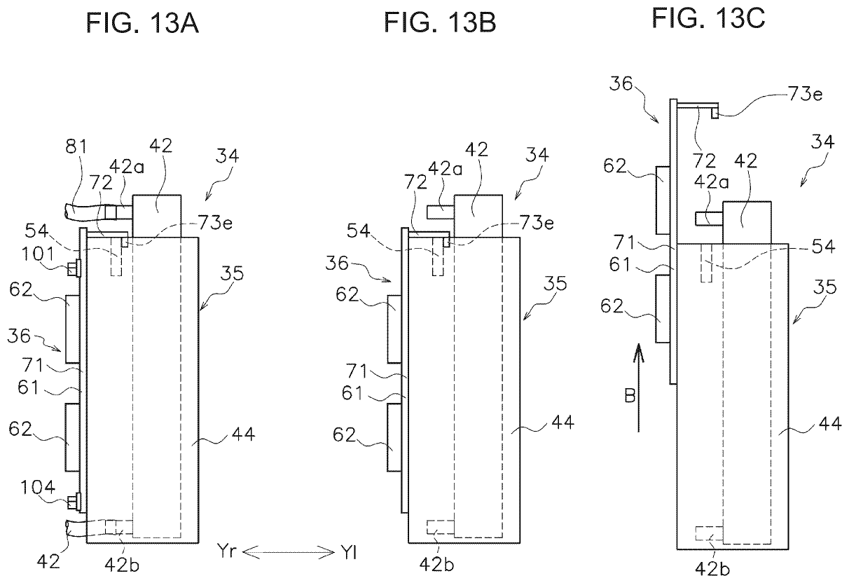

When the second frame 61 is attached to the first frame 44, the end portion 73e (see FIG. 8A) is disposed to the left of the upper right frame portion 54 (see FIG. 5) of the first frame 44 as illustrated in the following schematic view of FIG. 13C. The front portion 73b of the second frame 61 is disposed on the front portion 54b of the upper right frame portion 54, the inclined portion 73c of the second frame 61 is disposed on the inclined portion 54c of the upper right frame portion, and the front portion 73b of the second frame 61 is disposed on the front portion 54b of the upper right frame portion 54. In this way, the end portion 73e is disposed to the right of the upper right frame portion 54, and also the front portion 73b, the inclined portion 73c, and the rear portion 73d are placed on the upper right frame portion 54, allowing the second frame 61 to be locked to the first frame 44.

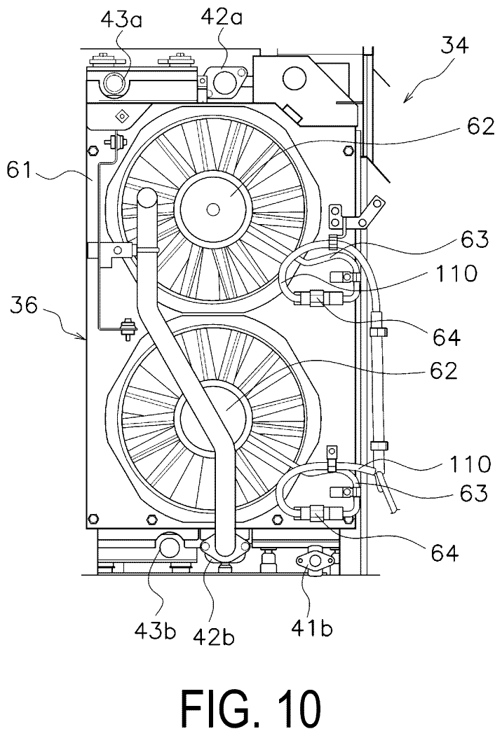

As illustrated in FIG. 8A, the first cables 63 are connected to the respective fans 62. The first cables 63 are provided to supply electric power to the respective fans 62. The connector portions 64 are connected to distal ends of the respective first cables 63. The connector portions 64 are fixed to the fan fixing portion 71 of the second frame 61. FIG. 10 is a front view of the cooling unit 34 illustrated in FIG. 3. As illustrated in FIG. 10, second cables 110 are detachably connected to the respective connector portions 64. The second cables 110 extend from a generator that generates electric power by being driven by the engine 33 and supply the electric power to the respective fans 62. When the fan unit 36 is detached from the heat exchanger unit 35, the second cables 110 are detached from the respective connector portion 64.

Fixation of the fan unit 36 to the heat exchanger unit 35 with the bolt 101 to a bolt 107 will be described. As illustrated in FIG. 7, the bolt 101 (an example of a first fixing portion) is inserted into the bolt hole 44a of the first frame 44 through the through hole 71a of the second frame 61. The bolt 102 (an example of the first fixing portion) is inserted into the bolt hole 44b of the first frame 44 through the through hole 45d of the upper cover frame 45 and the through hole 71b of the second frame 61. The bolt 103 (an example of the first fixing portion) is inserted into the bolt hole 44c of the first frame 44 through the through hole 71c of the second frame 61. The bolt 104 (an example of a second fixing portion) is inserted into the bolt hole 44d of the first frame 44 through the through hole 71d of the second frame 61. The bolt 105 (an example of the second fixing portion) is inserted into the bolt hole 44e of the first frame 44 through the through hole 71e of the second frame 61. The bolt 106 is inserted into the bolt hole 44f of the lower cover frame portion 56 through the through hole 71f of the second frame 61. The bolt 107 is inserted into the bolt hole 44g of the lower cover frame portion 56 through the through hole 71g of the second frame 61. Thus, the second frame 61 and the upper cover frame 45 are fixed to the first frame 44.

### Detachment of Fan Unit 36

Next, detachment of the fan unit 36 from the hydraulic excavator 1 will be described.

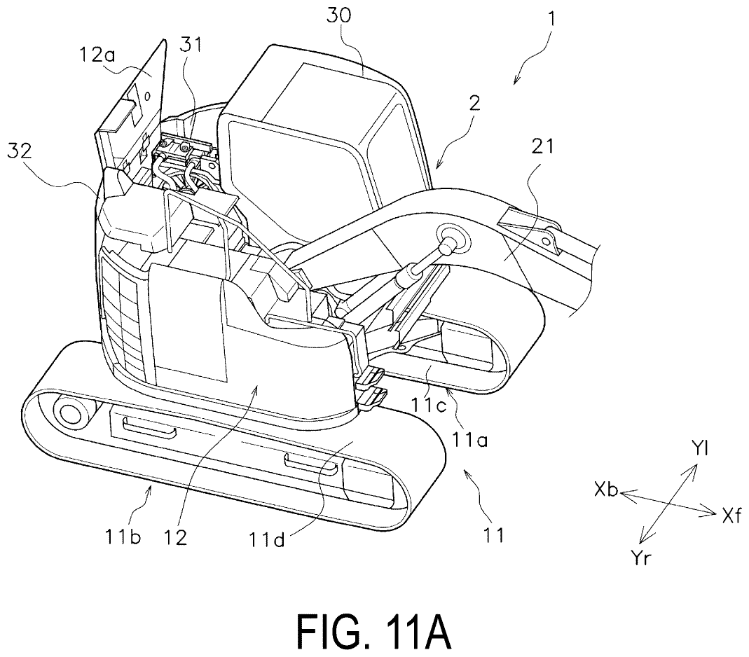

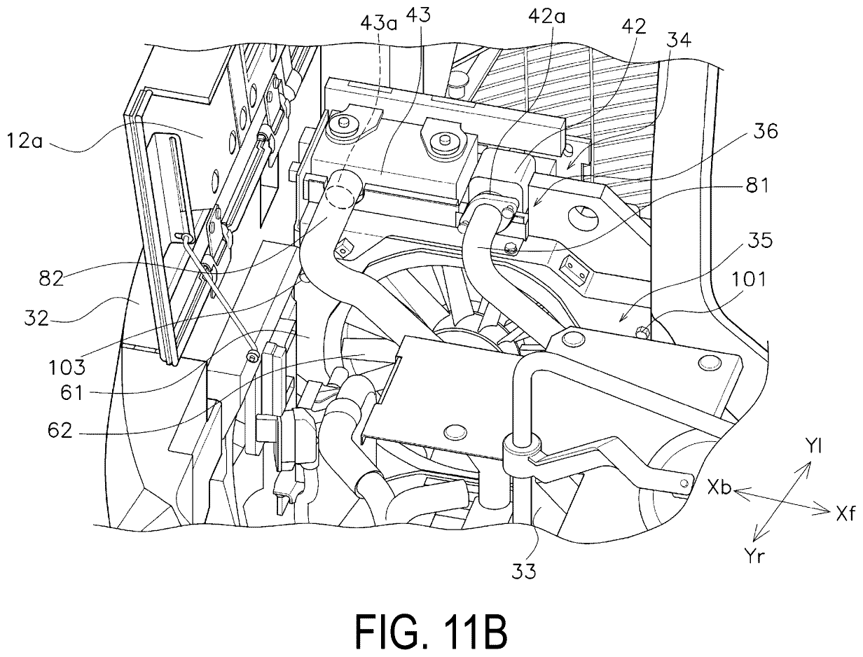

FIG. 11A is a perspective view illustrating the revolving body 12 of the hydraulic excavator 1. As illustrated in FIG. 11A, the engine room 31 includes a top cover 12a. A front end portion of the top cover 12a is vertically opened and closed with a rear end as a rotation axis. The rotation axis of the top cover 12a extends along the left-right direction. FIG. 11B is an enlarged view of a state in which the top cover 12a is opened. As illustrated in FIG. 11B, an operator can access an upper portion of the cooling unit 34 with the top cover 12a opened. In FIGS. 11A and 11B, a hose 81 is connected to the inflow port 42a of the aftercooler 42, and a hose 82 is connected to the inflow port 43a of the radiator 43. The inflow port 41a of the oil cooler 41 is not illustrated, and the hose connected to the inflow port 41a is also omitted.

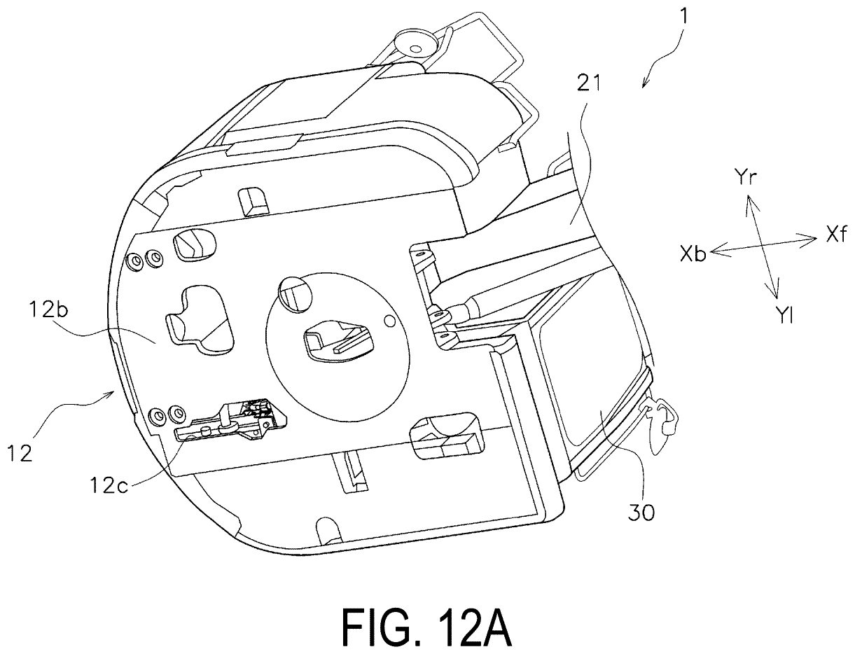

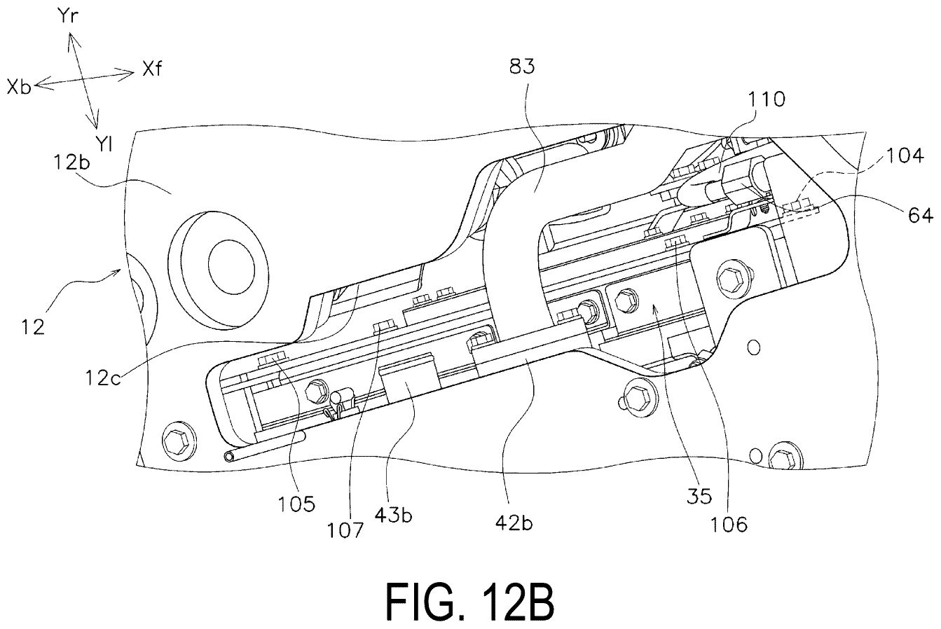

FIG. 12A is a view illustrating a bottom surface 12b of the revolving body 12 of the hydraulic excavator 1. As illustrated in FIG. 12A, a through hole 12c is formed in the bottom surface 12b of the revolving body 12. The through hole 12c extends through the bottom surface 12b to the engine room 31. Normally, the through hole 12c is covered with a cover (not illustrated). FIG. 12B is an enlarged view of FIG. 12A. As illustrated in FIG. 12B, the operator can access a lower portion of the cooling unit 34 from the through hole 12c. In FIG. 12B, a hose 83 is connected to the outflow port 42b of the aftercooler 42. The hose connected to the outflow port 43b of the radiator 43 is omitted, and the hoses connected to the outflow port 41b of the oil cooler 41 and the outflow port 43b are also omitted.

FIGS. 13A to 13C are schematic side views for describing operation of detaching the fan unit 36 from the heat exchanger unit 35. FIGS. 13A to 13C only illustrate the aftercooler 42 with the oil cooler 41 and the radiator 43 omitted.

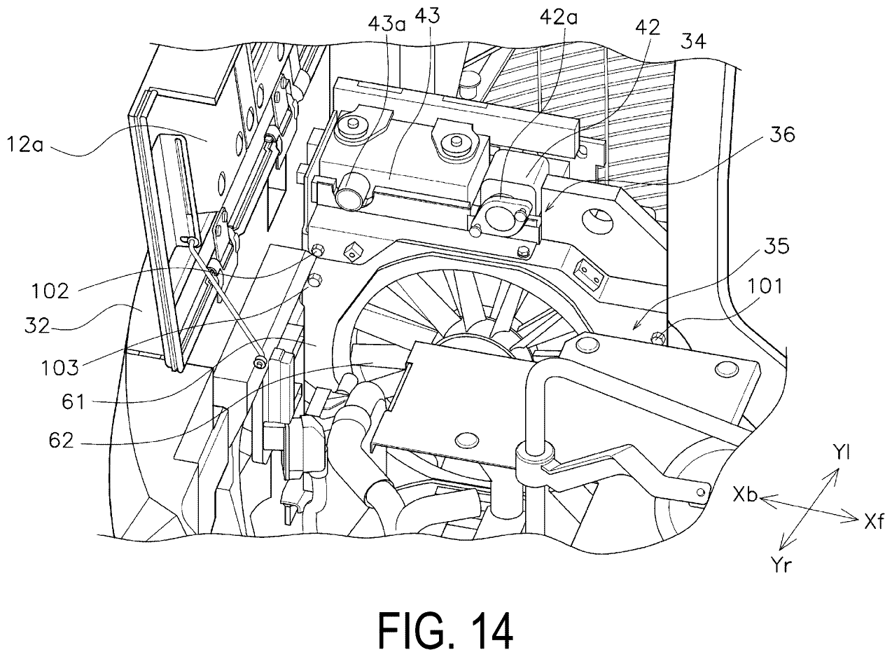

As illustrated in FIGS. 13A and 13B, the operator detaches the hose 81 connected to the inflow port 42a of the aftercooler 42 from the inflow port 42a. FIG. 14 is a view illustrating a state in which the hose 81 is detached from the inflow port 42a of the aftercooler 42. As illustrated in FIGS. 11B and 14, the operator detaches the hose 82 connected to the inflow port 43a of the radiator 43 from the inflow port 43a. Although not illustrated, the operator also detaches the hose connected to the inflow port 41a of the oil cooler 41. The operator then detaches the bolts 101, 102, and 103 illustrated in FIG. 14 from the first frame 44, the second frame 61, and the upper cover frame 45. FIG. 13A only illustrates the bolt 101 with the bolts 102 and 103 omitted. Although not illustrated, the operator detaches the upper second cable 110 illustrated in FIG. 10 from the connector portion 64 via the top cover 12a.

As illustrated in FIG. 13B, since the second frame 61 is locked to the first frame 44 by the first protruding portion 73, the second frame 61 can be prevented from falling from the first frame 44 even when the bolts 101 to 105 are detached.

The operator detaches the hose 83 (see FIG. 14) connected to the outflow port 42b of the aftercooler 42 from the outflow port 42b via the through hole 12c of the bottom surface 12b. Although not illustrated, the operator detaches the hose connected to the outflow port 41b of the oil cooler 41 from the outflow port 41b via the through hole 12c of the bottom surface 12b. Although not illustrated, the operator detaches the hose connected to the outflow port 43b of the radiator 43 from the outflow port 43b via the through hole 12c of the bottom surface 12b. The operator then detaches the bolts 104, 105, 106, and 107 illustrated in FIG. 12B from the first frame 44 and the second frame 61 via the through hole 12c. As illustrated in FIG. 12B, the operator detaches the lower second cable 110 from the connector portion 64 via the through hole 12c. The bolts 104, 105, 106, and 107 may be detached before the bolts 101, 102, and 103 are detached.

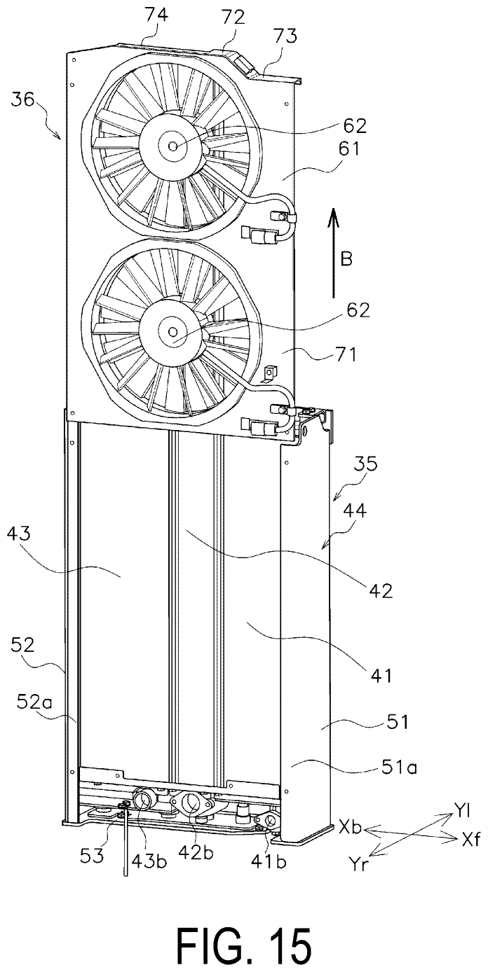

As illustrated in FIGS. 13B and 13C, the operator then moves the fan unit 36 upward with respect to the heat exchanger unit 35 (see arrow B). FIG. 15 is a view illustrating a state in which the fan unit 36 is moved upward with respect to the heat exchanger unit 35. Here, as illustrated in FIG. 9, the inflow port 41a does not overlap the protruding portion 72 or the fans 62 in the top view and does not interfere with the fan unit 36 even when the fan unit 36 is lifted upward in the vertical direction. The inflow port 43a does not overlap the second frame 61 in the top view and does not interfere with the second frame 61 even when the fan unit 36 is lifted upward in the vertical direction. Therefore, the fan unit 36 is lifted upward with respect to the heat exchanger unit 35 while the position in the front-rear direction is adjusted such that the inflow port 42a passes through the cutout portion 75 illustrated in FIG. 9. The fan unit 36 is lifted upward such that the fans 62 do not interfere with the inflow ports 42a and 43a.

The operator then takes out the fan unit 36 to the outside of the hydraulic excavator 1 via the top cover 12a.

As described above, since the fan unit 36 can be easily detached from the hydraulic excavator 1, the fans 62 can be easily replaced.

When the fan unit 36 is attached to the heat exchanger unit 35, a procedure reverse to the above is only required to be performed. Since the second frame 61 can be locked to the first frame 44 by the first protruding portion 73, positioning can be easily performed when the fan unit 36 is attached to the heat exchanger unit 35 with the bolts 101 to 107.

### Feature

(1)

The hydraulic excavator 1 of the present embodiment includes the heat exchanger, the first frame 44, the second frame 61, and the fans 62. The first frame 44 is disposed around the heat exchanger. The second frame 61 is detachably fixed to the first frame 44 and is thus disposed facing the heat exchanger. The fans 62 are fixed to the second frame 61 and driven by electric power. The second frame 61 is movable upward with respect to the first frame 44 after being unfixed from the first frame 44.

This allows the second frame 61 together with the fans 62 to be detached from the first frame 44 around the heat exchanger, further moved upward, and taken out from the hydraulic excavator 1. Therefore, the fans 62 can be easily replaced. The fans 62 may be removed from the second frame 61 that has been taken out and may be replaced, or the fans 62 and the second frame 61 may be replaced together.

(2)

In the hydraulic excavator 1 of the present embodiment, the second frame 61 includes the fan fixing portion 71 and the first protruding portion 73 (an example of the locked portion). The fan fixing portion 71 faces the heat exchanger, and the fans are fixed to the fan fixing portion 71. The first protruding portion 73 protrudes from the upper end portion of the fan fixing portion 71 toward the first frame 44. The first protruding portion 73 is locked to the upper portion of the first frame 44 from above.

In this way, since the second frame 61 is locked to the first frame 44 by the first protruding portion 73, the second frame 61 can be prevented from falling from the first frame 44 when the second frame 61 is detached from the first frame 44. In attaching the second frame 61 to the first frame 44, locking the upper portion of the first frame 44 to the first protruding portion 73 allows the second frame 61 to be positioned with respect to the first frame 44.

(3)

The hydraulic excavator 1 of the present embodiment further includes the engine room 31 (an example of a housing portion) and the bolts 101 to 103 (examples of the first fixing portion). The engine room 31 houses the heat exchanger, the first frame 44, the second frame 61, and the fans 62. The bolts 101 to 103 are disposed at the upper portion of the second frame 61 and fix the second frame 61 to the first frame 44. The engine room 31 includes the top cover 12a that is openable and closable. The bolts 101 to 103 are accessible with the top cover 12a opened.

This allows the operator to access the bolts 101 to 103 by opening the top cover 12a and unfix the second frame 61 from the first frame 44.

(4)

The hydraulic excavator 1 of the present embodiment further includes the engine room 31 and the bolts 104, 105, 106, and 107 (examples of the second fixing portion). The engine room 31 houses the heat exchanger, the first frame 44, the second frame 61, and the fans 62. The bolts 104, 105, 106, and 107 are disposed at the lower portion of the second frame 61 and fix the second frame 61 to the first frame 44. The engine room 31 includes the through hole 12c formed in the bottom surface 12b. The bolts 104, 105, 106, and 107 are accessible via the through hole 12c.

This allows the operator to access the bolts 104, 105, 106, and 107 via the through hole 12c and unfix the second frame 61 from the first frame 44.

(5)

In the hydraulic excavator 1 of the present embodiment, the second frame 61 further includes the protruding portion 72 protruding from the upper end portion of the fan fixing portion 71 toward the first frame 44 and including the first protruding portion 73. The heat exchanger includes the inflow port 42a (an example of an attachment port) disposed above the protruding portion 72, the hose 81 (an example of a pipe member) through which a refrigerant flows being attached to the inflow port 42a. The protruding portion 72 includes the cutout portion 75 below the inflow port 42a.

This allows the second frame 61 to be moved upward with respect to the first frame 44 such that the inflow port 42a passes through the cutout portion 75, allowing the second frame 61 to be easily taken out from the hydraulic excavator 1.

(6)

The hydraulic excavator 1 of the present embodiment further includes the engine 33 and the engine room 31. The engine room 31 houses the heat exchanger, the first frame 44, the second frame 61, the fans 62, and the engine 33. The vehicle body 2 includes the air port 31a through which air is sucked by the fans 62. The heat exchanger, the fans 62, and the engine 33 are arranged side by side in order from the air port 31a.

Since the fans 62 are disposed more inward than the heat exchanger as described above, influence of external electromagnetic waves or the like on the fans 62 can be reduced. Although turbulence is likely to occur downstream of the fans 62, air sucked by the fans 62 from the air port 31a hits the heat exchanger earlier than the fans 62 in the present embodiment. Therefore, rectified air can hit heat exchange, which can improve cooling efficiency.

(7)

The hydraulic excavator 1 of the present embodiment further includes the first cables 63, the second cables 110, and the connector portions 64. The first cables 63 are connected to the respective fans 62. The second cables 110 supply electric power to the respective fans 62. Although not illustrated, the operator detaches the hose connected to the outflow port 41b of the oil cooler 41 from the outflow port 41b via the through hole 12c of the bottom surface 12b. The connector portions 64 are disposed at the distal ends of the respective first cables 63, and the second cables 110 are detachably attached to the respective connector portions 64. The connector portions 64 are fixed to the second frame 61.

This allows, by detaching the second cables 110 from the respective connector portions 64, the second frame 61 to be detached from the first frame 44 and moved upward without interference with the cables.

### Other Embodiments

Although one embodiment of the present invention has been described above, the present invention is not limited to the above-described embodiment, and various modifications can be made without departing from the gist of the invention.

### (A)

In the above-described embodiment, the two fans 62 are arranged side by side in the up-down direction as illustrated in FIG. 2, but the number and arrangement of the fans 62 are not limited to the configuration illustrated in the drawing. The number of fans 62 may be one or three or more. The arrangement of the fans 62 is not limited to vertical arrangement, and the fans 62 may be arranged side by side in the front-rear direction of the vehicle.

### (B)

In the above-described embodiment, the air port 31a, the heat exchanger unit 35, the fan unit 36, and the engine 33 are arranged in order from the left to the right. However, the arrangement order is not limited to this order and the arrangement direction is not limited to the left-right direction.

### (C)

In the above-described embodiment, the upper cover frame 45 and the lower cover frame portion 56 are provided in the gap between the fan unit 36 and the heat exchanger unit 35, but the upper cover frame 45 or the lower cover frame portion 56 does not need to be provided.

### (D)

In the above-described embodiment, the fan unit 36 is fixed to the heat exchanger unit 35 with the bolts 101 to 105 in the vicinity of the upper end and in the vicinity of the lower end, but no such limitation is intended. The fan unit 36 is only required to be fixed to the heat exchanger unit 35 at a position accessible via the top cover 12a or the through hole 12c.

### (E)

In the above-described embodiment, the first protruding portion 73 is provided with the end portion 73e bent downward as illustrated in FIG. 8A, but it is only required that the first protruding portion 73 protrude along the left-right direction without the end portion 73e.

### (F)

In the above-described embodiment, the fan fixing portion 71 of the fan unit 36 is fixed to the lower cover frame portion 56. However, since the lower portion of the fan fixing portion 71 is fixed to the front frame portion 51 and the rear frame portion 52, the fan fixing portion 71 does not need to be fixed to the lower cover frame portion 56. Conversely, the lower portion of the fan fixing portion 71 does not need to be fixed to the front frame portion 51 or the rear frame portion 52 but may be fixed only to the lower cover frame portion 56.

### (G)

In the above-described embodiment, the hydraulic excavator has been described as an example of the work machine. However, the work machine is not limited thereto and may be a bulldozer, a wheel loader, a dump truck, a forklift, or the like.

The present disclosure has an effect of enabling a fan to be easily replaced and is useful for a work machine or the like.

1. A work machine, comprising:
a heat exchanger;
a first frame disposed around the heat exchanger;
a second frame detachably fixed to the first frame and disposed facing the heat exchanger; and
a fan fixed to the second frame and driven by electric power,
the second frame being movable upward with respect to the first frame after being unfixed from the first frame.

2. The work machine according to claim 1, wherein
the second frame includes
a fan fixing portion facing the heat exchanger and having a plate shape, the fan being fixed to the fan fixing portion, and
a locked portion protruding from an upper end portion of the fan fixing portion toward the first frame and engaging with an upper portion of the first frame from above.

3. The work machine according to claim 1, further comprising:
a housing portion housing the heat exchanger, the first frame, the second frame, and the fan; and
a first fixing portion disposed at an upper portion of the second frame and fixing the second frame to the first frame,
the housing portion including a top cover that is openable and closable, and
the first fixing portion being accessible with the top cover opened.

4. The work machine according to claim 1, further comprising:
a housing portion housing the heat exchanger, the first frame, the second frame, and the fan; and
a second fixing portion disposed at a lower portion of the second frame and fixing the second frame to the first frame,
the housing portion including a through hole formed in a bottom surface, and
the second fixing portion being accessible via the through hole.

5. The work machine according to claim 2, wherein
the second frame further includes a protruding portion protruding from the upper end portion of the fan fixing portion toward the first frame and including the locked portion,
the heat exchanger includes an attachment port disposed above the locked portion, a pipe member through which a refrigerant flows being attached to the attachment port, and
the protruding portion includes a cutout portion below the attachment port.

6. The work machine according to claim 1, further comprising:
an engine; and
a housing portion housing the heat exchanger, the first frame, the second frame, the fan, and the engine,
the housing portion including an air port through which air is sucked by the fan, and
the heat exchanger, the fan, and the engine being arranged side by side in order from the air port.

7. The work machine according to claim 1, further comprising:
a first cable connected to the fan;
a second cable supplying electric power to the fan; and
a connector portion disposed at a distal end of the first cable, the second cable being detachably attached to the connector portion,
the connector portion being fixed to the second frame.
